(19) United States
(12) Patent Application Publication
(10) Pub. No.: US 2007/0054715 A1
(43) Pub. Date: Mar. 8, 2007

(54) Display for multi-media game console

(75) Inventor: Juen Tien Peng, Chung Li (TW)

Correspondence Address: HDSL, 4331 STEVENS BATTLE LANE, FAIRFAX, VA, 22033, US

(73) Assignee: Action Electronics Co., Ltd.

(21) Appl. No.: 11/217,307

(22) Filed: Sep. 2, 2005

(51) Int. Cl. A63F 13/00

(52) U.S. Cl. 463/1

(57) ABSTRACT

A display for a multi-media game console. The display includes a camera and a microphone to satisfy all the functions that the game console can provide. Such that, users can play games as well as see and talk to others through Internet. The display can be utilized for a game system to entirely expand all the functions so that users can play games under an interactive environment with instant audio and video effect to increase fun.

### BACKGROUND OF THE INVENTION

The present invention relates to a display for a multi-media game console, and in particular to a portable display for a video game system such as Playstation® or Xbox®.

As the development of electrical products, many video game systems with great varieties of entertainment, such as Playstation® or Xbox®, have become more popular. These game systems fulfill people's life with fun and joy.

The game system normally includes a console and an audio-video cable to connect a portable display so that sound and image can be played though.

As the development of Internet, modern game systems have provided more functions such as Internet connection and website browse. However, the existing display for the game system cannot fully satisfy all the functions that the modern game system can provide. That is, the existing display actually limits the use of the function of the modern game system.

Therefore, there is a need to enhance the display for the game system so that the functions of the game system will not be limited.

### BRIEF SUMMARY OF THE INVENTION

The present invention is to provide a display for a multi-media game console. The display includes a camera and a microphone to satisfy the functions that the game console can provide. Such that, users can play games as well as see and talk to others through Internet

Accordingly, the display of the present invention is capable of directly combing with the multi-media game console. The display includes a display panel, an audio playing module, a camera and a microphone.

The various objects and advantages of the present invention will be more readily understood from the following detailed description when read in conjunction with the appended drawing.

### BRIEF DESCRIPTION OF THE DRAWINGS

FIG. 1 is a perspective view of a display for a multi-media game console according to the present invention.

FIG. 2 is a block diagram showing the connection of a display and a game console.

### DETAILED DESCRIPTION OF THE INVENTION

In order that those skilled in the art can further understand the present invention, a description will be described in the following in details. However, these descriptions and the appended drawings are only used to cause those skilled in the art to understand the objects, features, and characteristics of the present invention, but not to be used to confine the scope and spirit of the present invention defined in the appended claims.

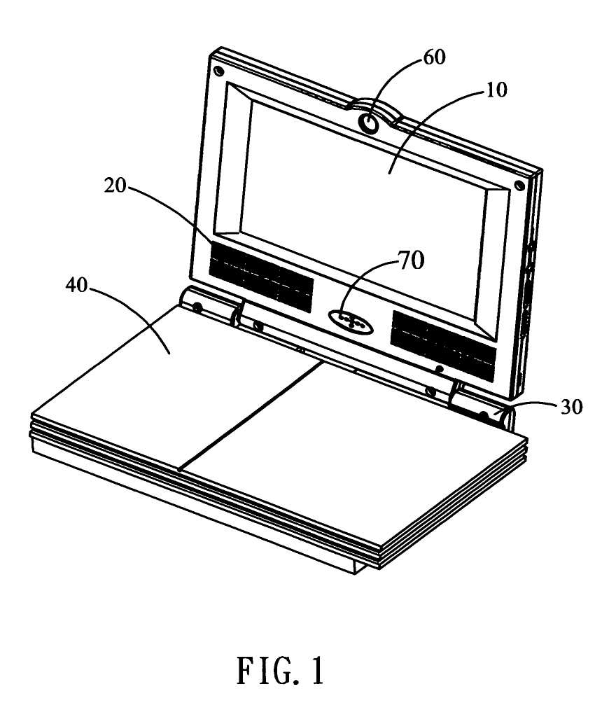

Referring to FIG. 1, the present invention provides a display for a multi-media game console 40. The display includes a display panel 10 and an audio playing module 20. The audio playing module 20 of the preferred embodiment includes two speakers located on a bottom side of the display panel, respectively. Moreover, the game console 40 includes a stand 30. The display panel 10 is pivotally connected to stand 30 so that the display of the present invention can directly combined with the game console 40.

Furthermore, the display of the present invention includes a camera 60 and a microphone 70. In the preferred embodiment, the camera 60 is disposed at the middle of the upper side of the display panel 10. The camera 60 is used to capture dynamic or still images. The microphone 70 is located between two speakers and at the middle of the bottom side of the display panel 10. The microphone 70 is used to input user's voice or other sound.

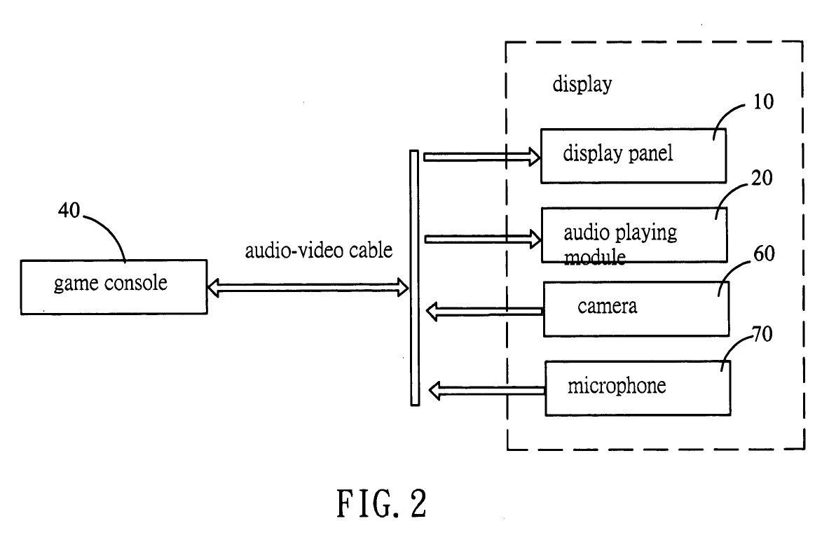

As shown in FIG. 2, after the user combines the display of the present invention with the game console 40, not only the image and sound can be played by the display but also the user can utilize the camera 60 to capture the dynamic or still images of himself or the surroundings for transmitting to the game console 40 via an audio-video cable. The game console 40 has the CPU to process the image signals; therefore, the images can be transmitted to others through Internet Also, the user can utilize the microphone 70 to input sound via the audio-video cable for transmitting to others after the sound signals are processed by the CPU of the console 40. Such that, the instant communication for a game system can be fulfilled.

It is easy to understand that the user can utilize the camera 60 and the microphone 70 provided by the display of the present invention to satisfy all the functions that the game console 40 can provide. That is, the user can play games as well as see and talk to others through Internet.

Further, in another preferred embodiment of the present invention, the camera 60 of the display can be pivotally installed on the display panel 10. Therefore, the camera 60 can capture images in different viewing angles.

As described above, the display of the present invention can be utilized for a modern game system to entirely expand all the functions so that users can play games under an interactive environment with instant audio and video effect to increase fun.

The present invention is thus described; it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A display capable of directly combing with a multi-media game console, the display comprising a display panel, an audio playing module, a camera and a microphone.

2. The display as claimed in claim 1, wherein the audio playing module is disposed on a bottom side of the display panel.

3. The display as claimed in claim 1, wherein the camera is disposed on an upper side of the display panel.

4. The display as claimed in claim 1, wherein the camera is pivotally installed on one side of the display panel.

5. The display as claimed in claim 1, wherein the microphone is disposed on one side of the display panel.

6. The display as claimed in claim 1, further comprising an audio-video cable to connect the camera and the microphone with the game console for transmitting signals.

7. The display as claimed in claim 1, wherein the game console includes a stand.

8. The display as claimed in claim 7, the display panel is pivotally connected to the stand.
